(19) United States
(12) Patent Application Publication
(10) Pub. No.: US 2018/0150331 A1
(43) Pub. Date: May 31, 2018

(54) COMPUTING RESOURCE ESTIMATION IN RESPONSE TO RESTARTING A SET OF LOGICAL PARTITIONS

(71) Applicant: International Business Machines Corporation, Armonk, NY (US)

(72) Inventors: Ping Chen, Austin, TX (US); Yiwei Li, Austin, TX (US); Hariganesh Muralidharan, Bangalore (IN)

(21) Appl. No.: 15/364,385

(22) Filed: Nov. 30, 2016

(51) Int. Cl. G06F 9/50

(52) U.S. Cl. CPC G06F 9/5077

(57) ABSTRACT

A method for determining and managing computing resources within a virtualized computing environment in response to restarting a set of partitions. The method includes at least one computer processor identifying a set of partitions affected by an event within a first computing system, the set of affected partitions is identified for restart. The method further includes creating a set of temporary partitions within a network accessible second computing system that correspond the affected set of partitions of the first computing system. The method further includes determining one or more sets of computing resources, of the second computing system, corresponding to the created temporary partitions. The method further includes deleting the set of temporary partitions. The method further includes provisioning a set of partitions within the second computing system based, at least in part, on the determined one or more sets of computing resources corresponding to the affected set of partitions.

### BACKGROUND OF THE INVENTION

The present invention relates generally to the field of data processing systems, and more particularly to migrating and restarting logical partitions among computing systems.

Within a virtualized computing environment, in response to an event or an error that causes an outage or fault affecting some or all of a computing system, some logical partitions are configured such that the logical partitions can be restarted remotely within a different physical computing system. For example, a partition provisioned using fully virtualized computing resources (e.g., computer processors, volatile memory, persistent storage, and input/output (I/O) devices) is more readily configured and restarted as opposed to a logical partition that is based on specific I/O hardware. Validating of partitions (e.g., identifying the computing resources of a partition) should be done on a periodic basis, since system outages are not readily predicted. In some instances, this periodic validation of one or more logical partitions to identify the computing resources allocated to a logical partition is referred to as a configuration “snapshot.” In response to a fault or outage within a computing system, a need will occur to migrate and restart at least one partition, and in some cases all of the logical partitions of the affected computing system within another computing system. Hence, the validation should also be done in such a way that multiple partitions can be moved to one or more target/destination computing systems.

### SUMMARY

Aspects of an embodiment of the present invention disclose a method, computer program product, and computing system for determining and managing computing resources within a virtualized computing environment in response to restarting a set of partitions. In an embodiment, the method includes at least one computer processor identifying a set of partitions affected by an event within a first computing system, the set of affected partitions is identified for restart. The method further includes creating a set of temporary partitions within a network accessible second computing system that correspond the affected set of partitions of the first computing system. The method further includes determining one or more sets of computing resources of the second computing system corresponding to the created temporary partitions. The method further includes deleting the set of temporary partitions. The method further includes provisioning a set of partitions within the second computing system based, at least in part, on the determined one or more sets of computing resources corresponding to the affected set of partitions.

### BRIEF DESCRIPTION OF THE DRAWINGS

FIG. 1 illustrates a networked computing environment, in accordance with an embodiment of the present invention.

FIG. 2 depicts a flowchart of steps of a system selection program, in accordance with an embodiment of the present invention.

FIG. 3 depicts a flowchart of steps of resource verification program, in accordance with an embodiment of the present invention.

FIG. 4 depicts a block diagram of components of a computer, in accordance with an embodiment of the present invention.

### DETAILED DESCRIPTION

Embodiments of the present invention recognize that within a networked computing environment that some portions of the environment include virtualized computing systems. In a virtualized computing system a hypervisor provisions physical and virtualized computing resources to various logical partitions that support the virtual machines (VMs), virtual appliances, containers, and the software applications utilized by users (e.g., customers). In addition, a computing system supporting virtualization may include one or more virtual I/O servers (VIOS) or partitions. A virtual I/O server is a software appliance with which associates physical I/O resources to virtualized I/O resources, such as virtual server adapters and virtual client adapters that enables such resources to be shared among multiple client logical partitions. A virtual I/O server provides virtual I/O resources to client partitions and enables shared access to physical I/O resource, such as disks, tape, and optical media. For example, a virtual I/O server can provide both virtualized storage and network adapters, making use of the virtual small computer system interface (SCSI) and virtual Ethernet facilities.

Embodiments of the present invention recognize that a networked computing environment may include: one or more computing systems that includes a plurality of interconnected physical resources (e.g., microprocessors, memory, storage devices, communication devices, etc.); a local group/cluster of computing systems, such as racks of blade servers, network-attached storage (NAS) systems, and storage area networks (SANs); distributed computing environments, such as a cloud infrastructure; or any combination thereof. To minimize impacts to users, in response to event within a computing system of a networked computing environment, one or more partitions of the affected computing system are automatically provisioned and restarted within another computing system of the networked computing environment that has unallocated computing (i.e., hardware) resources.

Embodiments of the present invention perform at least two levels of validation of computing resources associated with logical partitions (LPAR), herein referred to as partitions. A first validation (e.g., verification), or a “gross” validation, is performed to determine whether an identified (e.g., target) computing system can host a partition, or a set of partitions, of an affected computing system based on the unallocated resources of the identified computing system. Embodiments of the present invention can further analyze a validation, such as by verifying one or more types of computing resources by phase to minimize delays associated with locking unallocated computing resources. In an example, determining memory dictates for a partition of set of partitions is quicker than analyzing the details and key characteristics of I/O devices. Embodiments of the present invention perform a second validation within a target computing system to verify the computing resources to be utilized (e.g., provisioned) by each partition of a set of partitions. Similarly, the second validation may include multiple phases based on a type of computing resource to minimize delays associated with locking unallocated computing resources. In addition, the second validation determines whether the computing resources utilized by a partition change between the computing resources identified within a snapshot of a partition that executed on the affected computing system change in response to hosting the partition on a target computing system. For example, a target computing system may include computer processors and memory operating at a faster clock-speed that the affected computing system; therefore, the partition would need fewer virtual processors on the target computing system to achieve the same performance.

Embodiments of the present invention determine a set of computing resources utilized by each partition of a set of partitions (i.e., LPARs). Computing resources include, but are not limited to: central processing units (e.g., CPUs, cores, computer processors); volatile memory, such as random-access memory (RAM); non-volatile memory, such as flash memory; persistent storage, such as hard-disk drives and solid-state drives; communication and/or input/output (I/O) devices, such as host bus adapters (HBA), network interface cards (NICs), communication adapters, Fibre Channel (FC) adapters; etc. Various embodiments of the present invention are based on virtualized computing resources, and more specifically virtualized I/O resources. Other embodiments of the present invention are based on a combination of virtualized computing resources and physical computing resources. An embodiment of the present invention may be based on physical computing resources.

Some embodiments of the present invention further identify computing resource based on other criteria, key characteristics, and/or specialized capabilities, such as storage adapters, network adapters, accelerator adapters (e.g., co-processor cards), field-programmable gate array (FPGA) devices, adapters with embedded cryptographic capabilities, etc. Some I/O adapters and devices can reduce data processing performed by a CPU by processing the data within the adapter or device. Other embodiments of the present invention identify other key characteristics associated with one or more computing resources. Examples of key characteristics associated with computing resources include: a data processing rate (e.g., I/O operations per second (IOPS)), a protocol (e.g., Ethernet, FC, etc.), and/or a data transfer rate, such as bandwidth, etc.

Various embodiments of the present invention enable some degree of modification and/or substitution of physical and/or virtual computing resources of a partition. In an example, an embodiment of the present invention may substitute (e.g., allocate) a 2 Gbps Ethernet adapter for a 1 Gbps Ethernet adapter since the communication technology, Ethernet, is the same. In another example, an alternative (e.g., a substitute virtual or physical) I/O resource may be allocated for a partition, based on a key characteristic, such as TOPS. A 1 Gbps FC adapter may be utilized in lieu of a 2 Gbps Fibre Channel over Ethernet (FCoE) adapter, if the 1Gbsp FC adapter has an TOPS rate equal to or greater that the TOPS rate of the 2 Gbps FCoE adapter.

Embodiments of the present invention utilize temporary partitions within an identified computing system to more accurately estimate the computing resources utilized by each restarted (e.g., “live”) partition. An identified computing system may be referred to as a target computing system or a destination computing system. In one example, embodiments of the present invention utilize a temporary partition to determine the additional overhead (e.g., consumed computing resources) that are associated with a hypervisor managing the computing resources of a partition associated with a remote restart. In another example, embodiments of the present invention utilize a temporary partition to determine the additional overhead that are associated with virtualizing and/or substituting various computing resources of a partition. In addition, further overhead (e.g., consumed computing resources) associated with computing resource allocations (e.g., provisioning) can occur in response to virtualizing various computing resources, more specifically virtualizing I/O resources. To virtualize and shared a group of I/O resources (e.g., hardware), a hypervisor of a target computing system may provision one or more VIOS partitions in addition to creating a set of temporary partitions corresponding to a set of affected partitions.

Various embodiments of the present invention also can determine that some partitions are related, such that a set of partitions are dictated to execute within the same computing environment, node, or physical computing system. In an example, a business process, such as an online store may be comprised of a web server, an e-mail client, a file server, a database server, and a transaction server that may require a level of isolation to securely process customer information, such as credit card information. With respect to multiple validations, it is important that if the validation of the set of affected partitions is successful, then the remote restart or migration of the set of partitions occurs. In some instances, all affected partitions are hosted by a computing system that includes sufficient unallocated compute resources to support all the affected partitions.

In addition to determining relationships among partitions, other embodiments of the present invention can prioritize the validation of partitions and/or sets of partitions based on metadata or information associated with user. In an example, a load balancer or monitoring function (not shown) of a computing system may identify rates of utilization of partitions prior to a computing system experiencing an event. Based on the rates of utilization of partitions and relationships among partitions embodiments of the present invention can rank and prioritize an order in which partitions are validated, provisioned, and restarted.

Further, one skilled in the art would recognize that by utilizing temporary partitions to determine additional hypervisor overhead in addition to the computing resources utilized by a set of partitions to a target computing system that the chances of a migration failure for a set of partitions is reduced. An improvement of the estimation of actual computing resource required for provisioning a set of affected (e.g., migrated) partitions reduces the occurrence of rollbacks and delays associated with identifying another computing system to host the affected partitions; thereby, minimizing impacts to customers. In addition, by providing capabilities to lock allocation of computing resources of a computing system during a validation process, and by enabling the computing resources of dynamic partitions to be automatically adjusted, this further ensures a reduction in the occurrences of rollbacks (e.g., returning a computing system to a previous state in response to an error) associated with provisioning and restarting a set of affected partitions.

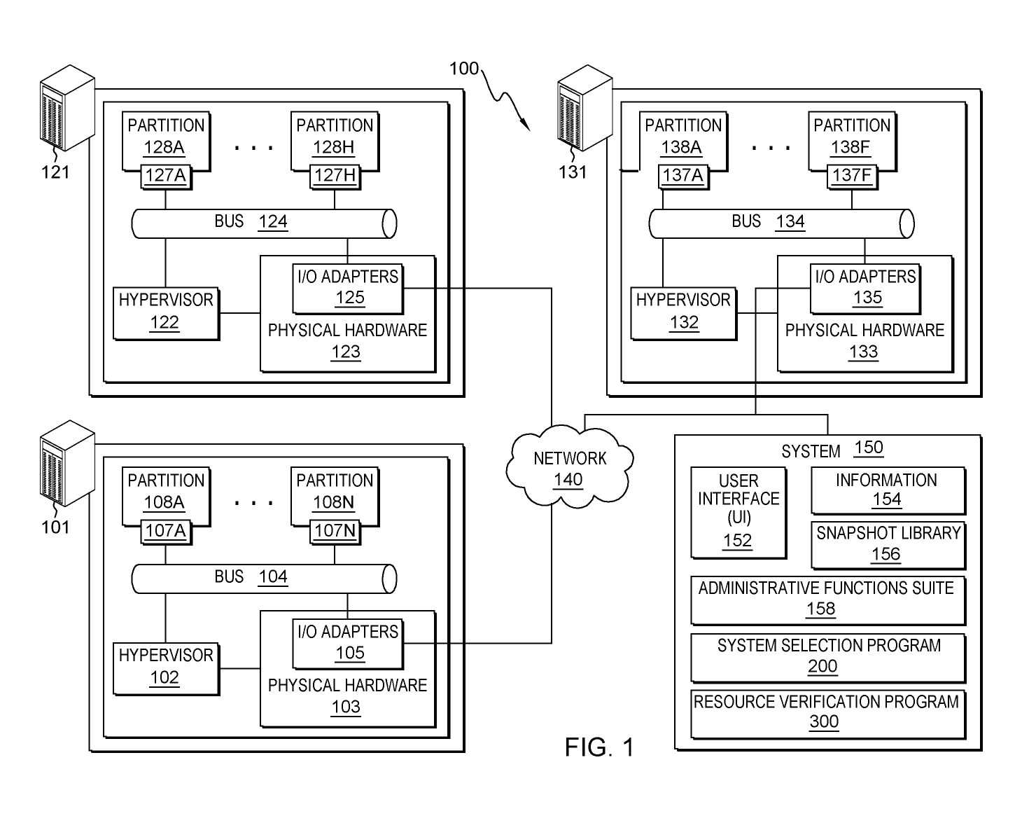

The present invention will now be described in detail with reference to the Figures. FIG. 1 is a functional block diagram illustrating a networked computing environment 100, which includes computing systems 101, 121, and 131 (i.e., a virtualized computing system), network 140, and system 150, in accordance with the present invention. In an embodiment, networked computing environment 100 includes a plurality of computing systems, such as computing systems 101, 121, and 131. In some embodiments, networked computing system 100 is representative of a local group of computing nodes of a larger computing system, such as a cloud computing system that is geographically distributed. In other embodiments, computing systems 101, 121, and 131 of networked computing system 100 are representative of computing systems at various geographic locations.

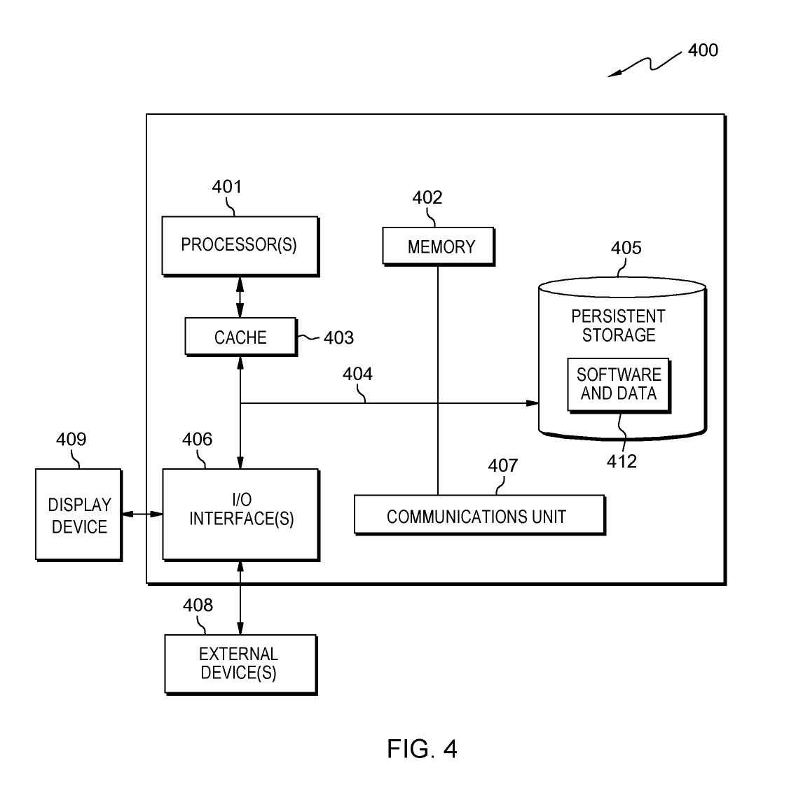

In one embodiment, system 150 represents a management console that performs various monitoring and administrative functions for computing systems 101, 121, and 131. In some embodiments, computing systems 101, 121, and 131 may each include an instance of system 150. System 150 may be: a laptop computer, a tablet computer, a netbook computer, a personal computer (PC), a desktop computer, a personal digital assistant (PDA), a smart phone, a communications terminal, a wearable device (e.g., digital eyeglasses, smart glasses, smart watches, etc.), or any programmable computer system known in the art. In certain embodiments, computing systems 101, 121, 131, and system 150 represent computer systems utilizing clustered computers and components (e.g., database server computers, application server computers, etc.) that act as a single pool of seamless resources when accessed through network 140, as is common in data centers and with cloud-computing applications. In general, computing systems 101, 121, 131, and system 150 are representative of any programmable electronic device or combination of programmable electronic devices capable of executing machine readable program instructions and communicating with users of computing systems 101, 121, 131, and system 150, via network 140. Computing systems 101, 121, 131, and system 150 may include components (e.g., physical hardware), as depicted and described in further detail with respect to FIG. 4, in accordance with embodiments of the present invention.

Computing systems 101, 121, and 131 respectively include: hypervisors 102, 122, and 132; physical hardware 103, 123, and 133; bus 104, 124, and 134; I/O adapters 105, 125, and 135. The physical hardware 103, 123, and 133 of respective computing systems 101, 121, and 131 include: pluralities of central processing units (e.g., CPUs, processors, cores); pluralities of communication devices; pluralities of volatile memory, such as random-access memory (RAM); and pluralities of persistent storage, such as hard-disk drives and solid-state drives (not shown). Physical hardware 103, 123, and 133 may also include: FPGAs, co-processors, flash memory, etc.

I/O adapters 105, 125, and 135 respectively include pluralities of I/O devices, cards, adapters, network switches, etc. I/O adapters 105, 125, and 135 may include: shared Ethernet adapters (SEAs), host bus adapters (HBAs), Ethernet adapters, etc. Various I/O adapters of I/O adapters 105, 125, and 135 are respectively virtualized to generate an plurality of virtual I/O resources within respective computing systems 101, 121, and 131.

Hypervisors 102, 122, and 132 may be stored in non-volatile memory of respective computing systems 101, 121, and 131, such as firmware (not shown) or embedded within hardware. Alternatively, hypervisors 102, 122, or 132 may be hosted hypervisors (e.g., software hypervisors) that execute within another operating system (OS). Computing systems 101, 121, and 131 may also include various programs and data (not shown) that enable the respective operations of computing systems 101, 121, and 131, such as one or more communication programs; virtualization software, such as I/O virtualization, N Port ID virtualization, hardware virtualization; various communication protocols; a library of templates (e.g., virtual machine (VM) templates, LPAR configuration templates), virtual appliances, software containers, middleware, etc. In an example, a virtual switch (not shown) may be embedded within virtualization software or may be included within the firmware of a computing system. In some embodiments, in addition to creating and managing the logical partitions and associated VMs, virtual appliances, and/or containers, hypervisor 102, 122, and/or 132 manages communication between the logical partitions and other systems within respective computing systems 101, 121, and 131 via one or more virtual switches. In an embodiment, some virtual switches and internal network communications are represented by bus 104, bus 124, and bus 134 of respective computing systems 101, 121, and 131.

In an embodiment, computing system 101 is divided into multiple partitions that include partitions 108A thru 108N. In an illustrated example, partition 108A and partition 108D each run an independent operating environment, such as an operating system (OS). In another example, partition 108B is a VIOS partition. Communication among partitions and/or from one or more partitions to network 140 occurs via a corresponding communication device of a partition as represented by communication devices 107A thru 107N. Communication devices 107A thru 107N may be physical network interface cards (NICs), virtual network interface cards (VNICs), or a combination thereof.

With respect to computing system 101 in one embodiment, communications to and from network 140 are routed through one or more communication devices included in an instance of I/O adapters 105, such as a host bus adapter (HBA) or via a SEA through bus 104 to a communication device of a partition, such as communication device 107C of partition 108C. In various embodiments, one or more communication devices of communication devices 107A thru 107N are virtual I/O devices (e.g., virtual I/O resources) derived from one or more I/O adapters of I/O adapters 105. In another embodiment, communications to and from network 140 are routed through one or more communication devices included in an instance of I/O adapters 105, such as a host bus adapter (HBA) or via a SEA through bus 104 to a VIOS partition associated with various communication devices and/or I/O adapters. In some instances, a partition may exclusively “own” (e.g., be allocated) an I/O adapter. In other instances, partitions may share an I/O adapter by utilizing a VIOS partition. In one example, a partition may utilize a virtual client Fibre Channel (FC) adapter that accesses a virtual FC server adapter within a VIOS partition, where the VIOS partition controls a physical FC adapter.

Similarly, with respect to computing systems 121 and 131 in one embodiment, communications to and from network 140 are routed through one or more communication devices included in respective instances of I/O adapters 125 and 135, such as a respective host bus adapter (HBA) or via a SEA through respective busses 124 and 134 to a communication device of a partition, such as communication devices 127A thru 127H of respective partitions 128A thru 128H of computing system 121, and communication devices 137A thru 137F of respective partitions 138A thru 138F of computing system 131. In various embodiments, one or more communication devices of communication devices 127A thru 127H are virtual I/O devices (e.g., virtual I/O resources) derived from one or more I/O adapters of I/O adapters 125 of computing system 121. Similarly, one or more communication devices of communication devices 137A thru 137F are virtual I/O devices (e.g., virtual I/O resources) derived from one or more I/O adapters of I/O adapters 135 of computing system 131. In another embodiment, communications to and from network 140 are routed through one or more communication devices included in respective instances of I/O adapters 125 and 135. In some instances, a partition may exclusively “own” an I/O adapter. In other instances, partitions may share an I/O adapter by utilizing a VIOS partition. In an example, communication device 127C is representative of a virtual client adapter that communicates via a virtual server adapter of a VIOS partition (not shown) that controls a physical adapter within I/O adapters 125.

In an illustrative example, computing system 121 and computing system 131 of networked computing environment 100 have unallocated computing resources. Whereas computing system 101 includes partitions 108A thru 108N, computing system 121 includes partitions 128A through 128H. Similarly, computing system 131 includes partitions 138A thru 138F.

In some embodiments, bus 104, bus 124, and/or bus 134 are generated by a software program that allows one partition to communicate with another partition utilizing various network fabrics, such as Fibre Channel switch fabric. Some or all of bus 104, bus 124, and/or bus 134 may be virtual local area networks (VLANs) that are generated utilizing various physical hardware resources of respective computing systems 101, 121, and/or 131. In other embodiments, computing systems 101, 121, and/or 131 may utilize other technologies, such as VMCI or VNICs, to enhance the communications within the computing system. In an embodiment, bus 104, 124, and/or bus 134 may be embedded into virtualization software or may be included in hardware of a computing system as part of the firmware of the computing system.

In various embodiments, bus 104, bus 124, and/or bus 134 may be a combination of physical and virtualized resource that communicate via fiber optic cables, Ethernet cables, wiring harnesses, printed wiring boards (e.g., backplanes), wireless connections, etc. Physical and virtual adapters within computing systems 101, 121, and/or 131 may utilize protocols that support communication via virtual port IDs (NPIV, World Wide Port Names (WWPNs)), that communicate with various portions of computing system 101, computing system 121, and/or computing system 131 via an internal communication system, such as bus 104, bus 124, and bus 134 respectively.

In some embodiments, computing systems 101, 121, and 131, and system 150 utilize network 140 to communicate, access one or more other computing nodes (not shown) of networked computing environment 100, and access other virtualized computing environments (e.g., a cloud computing environment). Network 140 can be, for example, a local area network (LAN), a telecommunications network, a wireless local area network (WLAN), a wide area network (WAN), such as the Internet, a communication fabric/mesh, or any combination of the previous, and can include wired, wireless, or fiber optic connections. In general, network 140 can be any combination of connections and protocols, such as Fibre Channel Protocol (FCP) that will support communications between system 150, computing system 101, and computing system 131, in accordance with embodiments of the present invention. In another embodiment, network 140 operates locally via wired, wireless, or optical connections and can be any combination of connections and protocols (e.g., NFC, laser, infrared, etc.). System 150 includes user interface (UI) 152 information 154, snapshot library 156, administrative functions suite 158, system selection program 200, and resource verification program 300. System 150 may also include various programs and data (not shown) that enable various embodiments of the present invention and/or system administration functions for networked computing environment 100. Examples of the various programs and data of system 150 may include: a web browser, an e-mail client, security software (e.g., a firewall program, an encryption program, etc.), a telecommunication app, a database management program, and one or more databases.

In an embodiment, UI 152 may be a graphical user interface (GUI) or a web user interface (WUI). UI 152 can display text, documents, forms, web browser windows, user options, application interfaces, and instructions for operation; and include the information, such as graphics, text, and sounds that a program presents to a user. In addition, UI 152 controls sequences/actions that the user employs to access and administrate network computing environment 100, and interface with system selection program 200 and/or resource verification program 300. In some embodiments, a user of system 150 can interact with UI 152 via a singular device, such as a touch screen (e.g., display) that performs both as an input to a GUI/WUI, and as an output device (e.g., a display) presenting a plurality of icons associated with apps and/or images depicting one or more executing software applications. In other embodiments, a software program, such as a web browser and/or one or more system administration functions can generate one or more instances of UI 152 operating within the GUI environment of system 150. In various embodiments, UI 152 may receive input in response to a user of system 150 utilizing natural language, such as written words or spoken words, that system 150 identifies as information and/or commands.

Information 154 includes information, such as an owner for a partition, metadata or other indications that identify a set of partitions that are related, such as predefined sets of related partitions, security information associated with a partition, a level of priority for a partition, and hosting constraints associated with a partition. In addition, information 154 can include a hierarchy of computing resource types to use for phases of a validation. For example, a first phase of a validation can be associated with determining whether sufficient memory and computer processors are available, a second phase may be associated with persistent storage, and a third phase of a validation can be associated with I/O resources. Information 154 may also include additional information associated with a partition, such as key characteristic information, parameter values associated with a computing resource or key characteristic, resource substitution criteria, utilization information, etc.

Snapshot library 156 includes snapshots of various portions of a computing system, such as system snapshots, configuration snapshots, process snapshots, and VM snapshots. A snapshot may be an image file, a read-only copy of various state information, or serialized. A snapshot may preserve the state information and data related to an aspect of a computing system that is the basis of a snapshot. In an example, a configuration snapshot for a partition (e.g., an LPAR) identifies the allocated: processors, computing resources, such as processors, I/O resources, volatile memory (e.g., RAM), persistent storage, etc. In some embodiments, snapshot library 156 includes configuration snapshots based on virtualized computing resources, and more specifically virtualized I/O resources. In other embodiments, snapshot library 156 includes configuration snapshots based on a combination of virtualized computing resources and physical computing resources. In an embodiment, snapshot library 156 includes configuration snapshots based on physical computing resources. A configuration snapshot can also include information, such as memory addresses, port ID's, WWPN's, target port IDs (e.g., SAN ports), etc.

System selection program 200 identifies a plurality of partitions affected by an event within a computing system of networked computing environment 100. Events that affect a computing system may include: a loss of electrical power to the computing system; a hardware failure that affects some or all of the computing system, such as within the computing system itself or associated with the network connections that enable the computing system to communicate among other computing system, and a prediction of failure of the computing system from a predictive analytics program (not shown).

System selection program 200 identifies a computing system to host sets of affected partitions (e.g., a gross validation) based on the unallocated resources of one or more target computing systems. System selection program 200 may execute concurrently with instances of resource verification program 300 executing in association with one or more computing systems of networked computing environment 100. In response to not identifying a computer system to host one or more affected partitions, system selection program 200 interfaces with an administrator of networked computing environment 100. In one embodiment, an instance of system selection program 200 is included within each instance of system 150 (e.g., a management console) that supports a computing system. In another embodiment, one instance of system selection program 200 is included within an instance of system 150 that manages multiple a computing systems, such as a master management console.

In some embodiments, an instance of system selection program 200 multicasts queries to a plurality of computing systems included within networked computing system 100 to identify the unallocated computing resources associated with each system. In some scenarios, system selection program 200 selects a computing system based on determining the computing system includes sufficient unallocated computing resources to host a set of related partitions. In other scenarios, system selection program 200 includes other information related the computing resources and/or dictates of a set of partitions to identify a computing system to host one or more sets of affected partitions. In various embodiments, in response to identifying a target computing system for a set of affected partitions, system selection program 200 transmits a set of information that includes the computing resources utilizes by each partition of a set of partitions and various key characteristic and substitution information to the target computing system.

Resource verification program 300 validates each partition of a set of affected partitions migrated to a target computing system. An instance of resource verification program 300 may execute concurrently within each computing system of networked computing environment 100 to await input (e.g., a message, a query) from an instance of system selection program 200 in response to identifying a computing system that is affected by an event. Alternatively, an instance of resource verification program 300 may initiate in response to a message or a query from an instance of system selection program 200 in response to system selection program 200 identifying a computing system that is affected by an event.

Resource verification program 300 creates temporary partitions that are used to determine a set of computing resources that an affected partition utilizes within a target computing system. By utilizing temporary partitions, resource verification program 300 provides a mechanism to account for (e.g., include) the overhead associated with a hypervisor to create a partition within a target computing system and the overhead associated with virtualization and/or substitutions of various computing resources, especially I/O resources. In one embodiment, resource verification program 300 validates partitions in a serial mode to ensure that a target computing system, upon provisioning resources for a set of partitions, has sufficient unallocated computing resources to host (e.g., provision and restart) the set of affects partitions. In some embodiments, resource verification program 300 interfaces with a functions of administrative functions suite 158 to restrict and/or prevent (e.g., lock) the hypervisor of a target computing system from allocating computing resources to other request to provision one or more other partitions, until resource verification program 300 terminates and/or is overridden by an administrator of the computing system.

In various embodiments, resource verification program 300 saves the information related to the computing resources associated with each partition of a set of partitions. Resource verification program 300 utilizes this information associated to provision the “live” partitions after deleting the temporary partitions and releasing the computing resources of the temporary partitions. By deleting the temporary partitions and provisioning “live” partitions, resource verification program 300 reduces any over-allocation of computing resources used to create the temporary partitions.

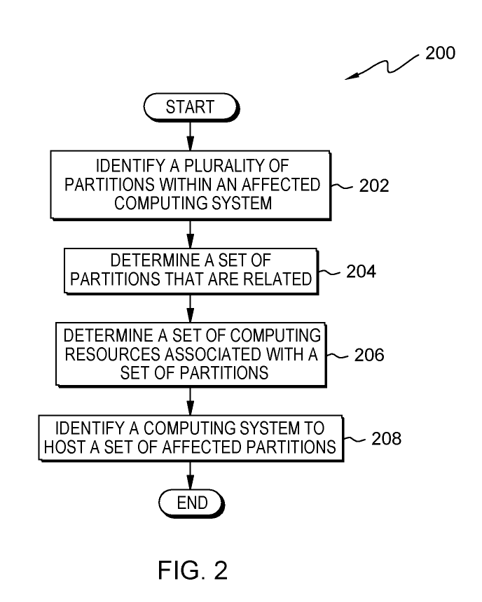

FIG. 2 is a flowchart depicting operational steps for system selection program 200 executing within networked computing environment 100 of FIG. 1. System selection program 200 is a program that identifies one or more computing system that have sufficient unallocated computing resources to provision and restart (e.g., host) one or more partitions in response to an event that affects the computing system that originally hosted the partitions, in accordance with embodiments of the present invention. In response to system selection program 200 identifying one or more computing system that have sufficient unallocated computing resources to provision and restart one or more affected partitions and/or sets of affected partitions, system selection program 200 transmits the information associated with affected partitions to the respectively identified computing systems. In various embodiments, system selection program 200 may execute concurrently with one or more instances of resource verification program 300.

In step 202, system selection program 200 identifies a plurality of partitions within an affected computing system. In response to an event affecting a computing system, system selection program 200 identifies a plurality of partitions within the affected computing system. Events that affect a computing system include: a loss of electrical power to the computing system, a hardware failure that affects some or all of the computing system, network connectivity faults that prevent the computing system from communicating among other computing systems, a prediction of failure of the computing system from a predictive analytics program (not shown), etc. In one embodiment, system selection program 200 identifies a plurality of partitions within an affected computing system based on a system snapshot, which includes a set of configuration snapshots of provisioned partitions of the computing system within snapshot library 156.

In another embodiment, system selection program 200 identifies a plurality of partitions to migration (e.g., to provision and to restart within another computing system) prior to a computing system being affected. In one scenario, system selection program 200 receives a message and/or command to migrate a plurality of partitions of computing system 101. In an example, system selection program 200 receives a message and/or command from an administrator of computing system 101, via UI 152 to migrate a plurality of partitions prior to an upgrade or maintenance of computing system 101. In another scenario, system selection program 200 receives a message and/or command from an automated function (not shown) to migrate a plurality of partitions of a computing system. In one example, system selection program 200 receives a message and/or command from a predictive analytics program (not shown) that based on information (e.g., return codes, event codes, hardware state values, etc.) within one or more system logs of computing system 101, that computing system 101 is predicted to fail in the near future. In another example, system selection program 200 receives a message (e.g., a warning) and/or command from an uninterruptible power supply (UPS) of computing system 101 that the UPS is nearing depletion; therefore, system selection program 200 identifies the plurality of partitions within computing system 101 prior to the depletion of power of the UPS.

In step 204, system selection program 200 determines a set of related partitions. In one embodiment, system selection program 200 identifies one or more sets of partitions of the plurality of partitions affected by the event within a computing system that are related. In one example, system selection program 200 determines that a set of partitions are related based predefined sets of partitions identified within information 154. In another example, system selection program 200 determines a set of related partitions based dictated hardware, such a sharing one or more cryptographic adapters that include the same firmware algorithms, or partitions that utilize the same storage adapter to share a set of defined initiator port addresses. In another example, system selection program 200 determines a set of related partitions based hardware specific communication methods and/or protocols, such a heap-based direct memory transfer or shared memory messaging-based data transfer.

In some embodiments, system selection program 200 determines a set (e.g., a group, a cluster, etc.) of related partitions based on one or more criteria included within information 154. System selection program 200 may determine relatedness among partitions based on: user dictates, such as a business function (e.g., an Internet store with on-line ordering and credit card processing); a level of priority associated with various partitions; security and/or compliance dictates; a ranking of usage of a partition within the plurality of partitions; communication information, such as WWPNs; or various combinations thereof.

In step 206, system selection program 200 determines a set of computing resources associated with a set of partitions. System selection program 200 may determine a set of computing resources associated with a set of partitions, such as a number of CPUs, a quantity of RAM, I/O resources (e.g., NICs, HBA's, storage adapters, etc.), a number and quantity of persistent storage, etc. System selection program 200 may determine computing resources associated with a partition based on virtualized resources and/or physical resources. In some embodiments, determining computing resources associated with a partition based on virtualized computing resources may provide a more granular description of a computing resource, such as four 3.0 GHz virtualized cores as opposed to four physical cores. In an example, if the target computing system has 3.4 GHz physical cores, then four 3.4 GHz physical cores is an over-allocation of resources for a partition that utilizes four 3.0 GHz virtualized resources.

In one embodiment, system selection program 200 determines a set of computing resources for a partition or each partition of a set of partitions based on information within a corresponding configuration snapshot of snapshot library 156. In another embodiment, system selection program 200 obtains information identifying a set of computing resources for partitions of computing system 101 prior to an occurrence of an event that affects computing system 101, such as a depletion of electrical power of a UPS that supports computing system 101.

In some embodiments, system selection program 200 determines other information associated a set of computing resources of one or more partitions of set of partitions, such as a computation rate (e.g., Floating-point Operations Per Second (FLOPS)), a data processing rate (e.g., TOPS), a protocol, a data transfer bandwidth, key characteristics or values of parameters, etc. In an example, system selection program 200 may define computational resources of a set of computing resources associated with a partition based on a value of 6 GFLOPS as opposed to four 3 GHz core or five 2.4 GHz cores. In a further embodiment, system selection program 200 determines additional information associated a set of computing resources associated with a partition, such as I/O resource substitution criteria, a range of values for computing resources, a range of values for other information (e.g., a computational rate of 4 to 6 GFLOPS), etc.

In step 208, system selection program 200 identifies a computing system to host a set of affected partitions. System selection program 200 may identify two or more computing system (e.g., targets computing systems, destination computing systems) within networked computing system 100 to host a set of affected partitions. In response to system selection program 200 identifying one or more computing system that have sufficient unallocated computing resources to provision and restart one or more affected partitions and/or sets of affected partitions, system selection program 200 transmits the information associated with affected partitions and/or set of partitions to an instance of resource verification program 300 associated with an identified computing system. Alternatively, in an embodiment, if system selection program 200 does not identify a computing system that has sufficient unallocated computing resources to provision and restart one or more affected partitions and/or sets of affected partitions, then system selection program 200 interfaces with an administrator of networked computing environment 100 via various instance of UI 152. System selection program 200 may communicate the computing resource information associated with each affected partition and the information associated with the unallocated resources of computing systems within networked computing environment 100 to an administrator via an instance of UI 152.

In one embodiment, system selection program 200 queries an instance of administrative functions suite 158 corresponding to each computing system of networked computing environment 100 (e.g., multicasts) to determine the unallocated computing resources of each target computing system. In another embodiment, system selection program 200 queries a master management console (e.g., a specific instance of system 150) that includes a version of snapshot library 156, which further includes configuration snapshots of each partition of networked computing environment 100; and a current set of computing resources, both allocated and unallocated, for each computing system of network computing environment 100.

In an example, system selection program 200 identifies that partitions 108A, 108B, 108C, 108D, and 108E are a first set of related partitions; and partitions 108G, 108H, and 108K are a second set of related partitions within computing system 101 affected by an event. Based on the configuration snapshots associated with each set of related partitions, system selection program 200 determines that computing system 131 has sufficient unallocated computing resources to host either or both sets of related partitions. However, computing system 121 has sufficient unallocated computing resources to host the second but not the first set of related partitions. Subsequently, system selection program 200 may determine the computing resource associated with each unrelated partition of computing system 101 to determine whether hosting both sets of related partitions on computing system 131 leaves sufficient unallocated computing resources between computing system 121 and 131 to distribute and host the unrelated partitions between computing system 121 and 131.

Referring again to step 208 in some embodiments, system selection program 200 utilizes various methods and/or criteria to identify two or more computing systems host various sets of partitions. In some scenarios, system selection program 200 may interface with instances of resources verification program 300 and instances of administrative functions suite 158 of respective instances of system 150 of computing systems within networked computing environment 100. System selection program 200 may modify the identification of computing systems to host affected partitions, based on an iterative process of: identifying a computing system, provisioning a first set of affected partitions, determining a new set of unallocated computing resources, and identifying a computing system to host a next set of affected partitions. In one scenario, system selection program 200 utilizes a priority criterion for sets of partitions. In another scenario, system selection program 200 may utilize various techniques, simulations, and/or algorithms (not shown) to identify and distribute individual partitions and sets of partitions such that, based on various criteria and/or constraints, such as a majority of the affected partitions, if not all the affected partitions are hosted among the computer systems of networked computing environment 100. Examples of constraints include: utilizing the fewest number of computing systems, restricting a usage of unallocated computing resource to 90% of initial unallocated computing resources, hosting high-priority partitions to computing system that can deploy the high priority partitions the quickest, and hosting cost-sensitive partitions to computing systems with lower cost computing resources.

In a further embodiment, if system selection program 200 identifies that one or more partitions of a set of affected partitions are dynamic partitions, then system selection program 200 reduces one or more computing resource values to a setting below a computer resource setting value associated with a corresponding configuration snapshot but greater than the minimum allocation setting value corresponding to the computing resource associated with the affected dynamic partition. System selection program 200 may utilize various criteria to determine which affected dynamic partition is selected for a reduction associated with a computing resource and the extent of the reduction of the computing resource. System selection program 200 may distribute reductions of computing resources among dynamic partitions as opposed to minimizing the computing resources associated with a few dynamic partitions.

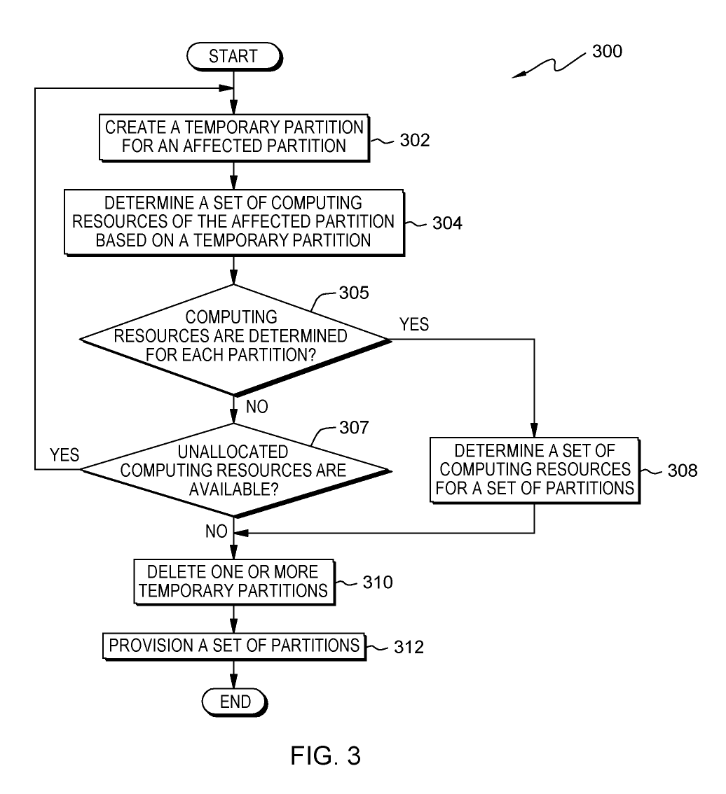

FIG. 3 is a flowchart depicting operational steps for resource verification program 300 executing within one or more computing system networked computing environment 100 of FIG. 1. Resource verification program 300 is a program that verifies whether an identified/target computing system, upon provisioning resources for a set of partitions, has sufficient unallocated computing resources to host (e.g., provision and restart) the set of affected partitions, in accordance with embodiments of the present invention. In one embodiment, an instance of resource verification program 300 can execute concurrently within each computing system within networked computing environment 100, await input from an instance of system selection program 200. In another embodiment, an instance of resource verification program 300, associated with a computing system, executes in response to a communication (e.g., a message, a query) from an instance of system selection program 200. In some embodiments, resource verification program 300 interfaces with a functions of administrative functions suite 158 to restrict and/or prevent (e.g., lock) the hypervisor of a target computing system from allocating computing resources until resource verification program 300 terminates and/or is overridden by an administrator of the computing system.

In step 302, resource verification program 300 creates a temporary partition for an affected partition. In response to receiving, from an instance of system selection program 200, information associated with a set of affected partitions to host, resource verification program 300 creates a temporary partition within a computing system for an affected partition. Resource verification program 300 creates a temporary partition utilizing unallocated computing resources of a target computing system, such as computing system 131. In some scenarios, resource verification program 300 creates temporary partitions utilized to validate the computing resources of a set of partitions in a serial mode (e.g., one at a time). In other scenarios, resource verification program 300 creates two or more temporary partitions utilized to validate the computing resources of a set of partitions in a parallel mode. In an example, system selection program 200 determines that computing system 121 includes 400% more unallocated computing resources than the computing resources associated with a set of high-priority partitions. Resource verification program 300 may create, in parallel, a set of temporary partitions corresponding to each partition of the set of high-priority partitions.

In one embodiment, resource verification program 300 creates a temporary partition based on information related to a set of computing resources of a set of affected partitions. In one scenario, resource verification program 300 creates a temporary partition based on information within a configuration snapshot of an affected partition, stored within an instance of snapshot library 156. In another scenario, resource verification program 300 creates a temporary partition based on information related to a set of computing resources within the information received from an instance of system selection program 200, such as a partition configuration determined prior to an event that affects computing system 101. In another embodiment, resource verification program 300 over-allocates one or more computing resources of a temporary partition by a threshold value to accommodate hypervisor-related overhead. Over-allocation values may be a percentage, a fixed amount, or a combination thereof and may be different for each computing resource. In some scenarios, resource verification program 300 may obtain over-allocation thresholds/values for a temporary partition from information 154. In other scenarios, resource verification program 300 receives over-allocation thresholds/values for a temporary partition from an administrator of a target computing system. In various scenarios, resource verification program 300 obtains over-allocation thresholds/values for a temporary partition from a combination of sources.

Referring again to step 302 in various embodiments, resource verification program 300 creates a temporary partition for a dynamic partition based on a reduced set of computing resources that are equal to or greater than the minimum values of computing resources defined for the dynamic partition and the values of computing resources within a configuration snapshot. In some embodiments, resource verification program 300 creates a temporary partition that is a dynamic partition. In one scenario, resource verification program 300 initially over-allocates a set of computing resources. Resource verification program 300 over-allocates computing resources, such as memory to account additional overhead associated with a hypervisor and/or virtualization support for virtualizing one or more computing resources. In another scenario, resource verification program 300 reduces the allocated set of computing resources based on various key characteristics associated with an affected partition, such as TOPS. In an example, resource verification program 300 may reduce the number of cores based on the TOPS of a partition in response to determining that the cores of a target computing systems have a higher clock-rate than the cores of the affected computing system.

In other embodiments, resource verification program 300 creates another temporary partition to validate another partition of a set of partitions. In one scenario, if resource verification program 300 determines that unallocated computing resources are available, then resource verification program 300 loops to create another temporary partition (Yes branch, decision step 307). In another scenario, resource verification program 300 creates a temporary partition in response to the deletion of one or more partitions and a re-allocation of computing resources based on a modified set of configuration (e.g., partition) resources.

Still referring to step 302 in a further embodiment, resource verification program 300 creates a temporary partition based one or more substitutions of computing resources. In one scenario, in response to resource verification program 300 determining that one or more computing resources are not available, resource verification program 300 may utilize one or more substitution criteria associated with an affected partition to determine an alternative set of computing resources for a temporary partition. In another scenario, resource verification program 300 may determine that another VIOS partition is include with a set of affected partitions based on the affected partitions utilizing an I/O hardware resource that is virtualized but constrained to the set of affected partitions, such as a security or isolation constraint.

In step 304, resource verification program 300 determines a set of computing resources of the affected partition based on a temporary partition. In one embodiment, resource verification program 300 determines (e.g., estimates) the computing resources of an affected partition based on virtualized computing resources, in particular virtual I/O resources, and the associated hypervisor overhead associated with the temporary partition. In another embodiment, resource verification program 300 determines the computing resources of an affected partition based on physical resources allocated to a temporary partition. In some embodiments, resource verification program 300 determines the computing resources of an affected partition based on a combination of virtualized computing resources, physical computing resources, and the associated hypervisor overhead for the temporary partition.

In other embodiments, resource verification program 300 determines the computing resources of an affected dynamic partition associated with a temporary partition based on a reduction of computing resources associated with a range of values for computing resources associated with the dynamic partition. In various embodiments, resource verification program 300 utilizes one or more functions of administrative functions suite 158 to determine the current computing resources of a temporary partition as opposed to the computing resource allocated to create the temporary partition. In a further embodiment, resource verification program 300 determines a set of computing resources for an affected partition based on various substitution criteria of computing resources, in particular I/O resources.

In decision step 305, resource verification program 300 determines whether computing resources are determined for each partition. In one embodiment, resource verification program 300 determines that computing resources are determined for each partition of a set of partitions received from an instance of system selection program 200. In another embodiment, resource verification program 300 determines that computing resources are determined for each partition of a set of partitions based on one or more inputs of an administrator of system 150. In an example, an administrator of system 150 via UI 152 deletes one or more unrelated partitions from a set of partitions received from system selection program 200. In response, resource verification program 300 determines that computing resources are determined for each partition of the modified set of partitions (e.g., sans the deleted unrelated partitions) received from an instance of system selection program 200.

In response to determining that computing resources are not determined for each partition (No branch, decision step 305), resource verification program 300 determines whether unallocated computing resources are available (decision step 307).

In decision step 307, resource verification program 300 determines whether unallocated computing resources are available. In one embodiment, resource verification program 300 determines that unallocated computing resources are available based on querying a function of administrative functions suite 158 associated with a computing system. In response, resource verification program 300 receives information identifying the unallocated computing resources of the computing system. In one scenario, resource verification program 300 prioritizes whether unallocated computing are available based on the hierarchy of resource types identified for performing a gross validation, such as prioritizing the verification of the quantity of memory utilized by a partition with respect to unallocated memory of a target computing system. In another embodiment, resource verification program 300 utilizes a function of administrative functions 158 to release over-allocated computing resources of one or more temporary partitions prior to determining whether unallocated computing resources are available. In some embodiments, resource verification program 300 performs a validation on another partition of the set of affected partitions to determine whether the available unallocated computing resources are sufficient to create a temporary partition.

In various embodiments, resource verification program 300 delays initiating an action of decision 307 until a response is received from an administrator of the target computing system. In one scenario, resource verification program 300 transmits a message to UI 152 that the target computing system does not include sufficient unallocated computing resources to create one or more temporary partitions for a set of affected partitions. In response, resource verification program 300 delays while monitoring for one or more changes affecting the unallocated computing resources of a computing system and/or the computing resources associated with one or more unprocessed partitions of the set of affected partitions. In one example, resource verification program 300 determines that the unallocated resources of computing system 121 increase in response to an administrator modifying the computing resources assigned to a low-priority dynamic partition. In another example, resource verification program 300 determines that the computing resources associated with an affected partition are reduced based on one or more modifications to the configuration values of an affected dynamic partition.

In response to determining that unallocated computing resources are available (Yes branch, decision step 307), resource verification program 300 loops to step 302 to create another temporary partition for another affected partition of the set of received affected partitions.

Referring to decision step 305, in response to determining that computing resources are determined for each partition (Yes branch, decision step 305), resource verification program 300 determines a set of computing resources associated with a set of partitions (step 308).

In step 308, resource verification program 300 determines a set of computing resources associated with a set of partitions. In one embodiment, resource verification program 300 generates a configuration file and/or configuration snapshot of each partition of the set of affected partitions corresponding to a target computing system. Resource verification program 300 subsequently utilizes the generated configuration files and/or configuration snapshots to provision a one or more “live” partitions in response to deleting one or more temporary partitions (discussed in further detail with respect to step 312 of resource verification program 300).

In another embodiment, resource verification program 300 determines the set of computing resources, including hypervisor overhead, associated with each partition of a set of affected partitions based on the set of actual computing resource of a temporary partition. In various embodiments, resource verification program 300 utilizes a function of administrative functions 158 to whether over-allocated computing resources are associated with one or more temporary partitions prior to determining a set of computing resources associated with a set of partitions. If resource verification program 300 determines that a temporary partition includes one or more over-allocated computing resources, the resource verification program 300 deducts the over-allocation of computing resources when determining the set of computing resources for a partition. In some embodiments, resource verification program 300 determines the total computing resources, including hypervisor overhead, for a set of affected partitions based on the computing resources associated with a set of temporary partitions.

In response to determining a set of computing resources for a set of partitions, resource verification program 300 deletes one or more partitions (step 310). Alternatively, referring to decision 307, in response to determining that unallocated computing resources are not available (No branch, decision step 307), resource verification program 300 deletes one or more temporary partitions (step 310).

In step 310, resource verification program 300 deletes one or more temporary partitions. Resource verification program 300 deletes one or more temporary partitions of a target computing system to release the computing resources allocated to the temporary partitions. In one embodiment, in response to resource verification program 300 determining that a target computing system cannot validate a set of related partitions (e.g., insufficient unallocated resources), resource verification program 300 deletes the one or more temporary partitions of the set of affected partitions that were validated. In another embodiment, resource verification program 300 deletes a set of temporary partitions associated with the set of affected partitions that is verified.

In some embodiments, resource verification program 300 communicates with a hypervisor of a target computing system to delete one or more temporary partitions and release the set of computing resources associated with the one or more temporary partitions. In other embodiments, resource verification program 300 utilizes one or more functions of administrative functions suite 158 to delete one or more temporary partitions and release the set of computing resources associated with the one or more temporary partitions.

In step 312, resource verification program 300 provisions a set of partitions. Resource verification program 300 utilizes the configuration information or configuration snapshots of partitions to provision a set of partitions. In response to provisioning a set of partitions, resource verification program 300 may restart a set of provisioned partitions. In one embodiment, in response to resource verification program 300 determining a set of computing resources for a set of affected partitions, resource verification program 300 provisions a set of “live” partitions (e.g., a set of partitions to restart) within a target computing system. In various embodiments, if resource verification program 300 determines that an affected partition is a dynamic partition based on information within a corresponding configuration snapshot, then resource verification program 300 provisions the corresponding partition as a dynamic partition. Resource verification program 300 may include the range of parameters (e.g., value of computing resources) within the definition of the dynamic partition corresponding to the configuration snapshot of the dynamic partition. However, resource verification program 300 provisions the computing resources corresponding to the dynamic partition based on the set of computing resources determined in Step 304.

In some embodiments, resource verification program 300 delays provisioning and restarting a set of partitions. In one scenario, resource verification program 300 delays provisioning and restarting a set of partitions until multiple sets of partitions are verified. In another scenario, resource verification program 300 delays provisioning and restarting a set of partitions until an administrator of the target computing system responds via UI 152. In an example, resource verification program 300 delays provisioning a set of partitions until an administrator of computing systems 121 and 131 determines which computing system hosts a plurality of partitions of computing system 101. In other embodiments, if resource verification program 300 cannot allocate a set of computing resource for a set of affected partitions, then resource verification program 300 terminates.

FIG. 4 depicts computer system 400, which is representative of computing system 101, computing system 121, computing system 131, and system 150. Computer system 400 is an example of a system that includes software and data 412. Computer system 400 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402. With respect to computing systems 101, 121, and 131, processor(s) 401, memory 402, and cache 403 are respectively included in physical hardware 103, 123, and 133 depicted in FIG. 1.

Program instructions and data used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information. With respect to computing systems 101, 121, and 131, persistent storage 405 respectively included in physical hardware 103, 123, and 133 depicted in FIG. 1.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 412 are stored in persistent storage 405 for access and/or execution by one or more of the respective processor(s) 401 via cache 403 and one or more memories of memory 402. With respect to computing systems 101, 121, and 131, software and data 412 respectively includes: hypervisors 101, 122, and 132 and other programs and data (not shown). With respect to system 150, software and data 412 includes: UI 152, information 154, snapshot library 156, administrative functions suite 158, system selection program 200, resource verification program 300, and other programs and data (not shown).

Communications unit 407, in these examples, provides for communications with other data processing systems or devices, including resources of computing system 101, bus 104, computing system 121, bus 124, computing system 131, bus 134, and system 150. In these examples, communications unit 407 includes one or more network interface cards. Communications unit 407 is representative of one or more communication devices and/or I/O adapters of I/O adapters 105, 125, and 135. Communications unit 407 may provide communications through the use of either or both physical and wireless communications links. With respect to computing system 101, hypervisor 102, software and data 412, and program instructions and data, used to practice embodiments of the present invention may be downloaded to persistent storage 405 through communications unit 407.

In addition, with respect to computing system 101, communications unit 407 includes, at least in part, one or more physical and/or virtualized network cards of physical hardware 103; and/or communication devices 107A thru 107N depicted in FIG. 1 to share among partitions and/or interfacing with network 140. With respect to computing system 121, communications physical hardware 123, communication devices 127A thru 127H depicted in FIG. 1 to be shared among partitions and/or interfacing with network 140. With respect to computing system 131, communications unit 407 includes, at least in part, one or more physical and/or virtualized network cards of physical hardware 133, communication devices 137A thru 137F depicted in FIG. 1 to be shared among partitions and/or interfacing with network 140.

I/O interface(s) 406 allows for input and output of data with other devices that may be connected to each computer system. For example, I/O interface 406 may provide a connection to external devices 408, such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display device 409.

Display device 409 provides a mechanism to display data to a user and may be, for example, a computer monitor. Display device 409 can also function as a touch screen, such as the display of a tablet computer or a smartphone.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is understood in advance that although this disclosure discusses system virtualization, implementation of the teachings recited herein are not limited to a virtualized computing environment. Rather, the embodiments of the present invention are capable of being implemented in conjunction with any type of clustered computing environment now known (e.g., cloud computing) or later developed.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining and managing computing resources within a virtualized computing environment, the method comprising:
identifying, by one or more computer processors, a set of partitions affected by an event within a first computing system, wherein the set of affected partitions is identified for restart;
creating, by one or more computer processors, a set of temporary partitions within a network accessible second computing system that correspond the affected set of partitions of the first computing system;
determining, by one or more computer processors, one or more sets of computing resources, of the second computing system, corresponding to the created set of temporary partitions;
deleting, by one or more computer processors, the set of temporary partitions; and
provisioning, by one or more computer processors, a set of partitions within the second computing system based, at least in part, on the determined one or more sets of computing resources corresponding to the affected set of partitions.

2. The method of claim 1, wherein creating the set of temporary partitions within the second computing system further comprises:
identifying, by one or more computer processors, a set of computing resources for an affected partition of the set of affected partitions based on a set of dictates corresponding to the affected partition of the set of affected partitions;
determining, by one or more computer processors, whether the second computing system has sufficient unallocated computing resource to create a temporary partition based on the set of dictates corresponding to the affected partition; and
in response to determining that the second computing system has sufficient unallocated computing resource to create a temporary partition based on the set of dictates corresponding to the affected partition, creating, by one or more computer processors, the temporary partition corresponding to the partition of the set of the affected partitions.

3. The method of claim 1, further comprising:
determining, by one or more computer processors, that the second computing system that includes sufficient unallocated computing resources to provision the set of affected partitions within the second computing system based on a configuration snapshot corresponding to each partition of the set of affected partitions.

4. The method of claim 2, wherein the temporary partition is over-allocated with computing resources by a threshold amount to accommodate an increase usage of computing resources to accommodate computing resources consumed by a hypervisor of the second computing system to create the temporary partition and virtualize one or more computing resource of the second computing system.

5. The method of claim 2, wherein determining whether the second computing system has sufficient unallocated computing resource to create a temporary partition based on the set of dictates corresponding to the affected partition further comprises:
determining, by one or more computer processors, whether the second computing system has sufficient unallocated computing resources based on a hierarchy of computing resource types; and
identifying, by one or more computer processors, memory as a first computing resource type of the hierarchy of computing resource types.

6. The method of claim 2, wherein the set of computing resources for each partition of the set of affected partitions is dictated based, at least in part on a configuration snapshot corresponding to the partitions of the set of affected partitions, wherein the configuration snapshot of a partition is created based on information obtained by from a hypervisor of the first computing system, and wherein configurations snapshots are stored on a network accessible computing system that is not affected by the event that affects the first computing system.

7. The method of claim 2, wherein creating a temporary partition of the set of temporary partitions within the second computing system occurs in a serial manner.

8. The method of claim 1, wherein the event within the first computing system is selected from the group consisting of:
a hardware fault within the first computing system;
a network connectivity failure;
a warning of a loss of electrical power to the first computing system; and
a prediction of failure of the first computing system.

9. A computer program product for determining and managing computing resources within a virtualized computing environment, the computer program product comprising:
one or more computer readable storage media and program instructions stored on the one or more computer readable storage media, the program instructions readable/executable by one or more computer processors:
program instructions to identify a set of partitions affected by an event within a first computing system, wherein the set of affected partitions is identified for restart;
program instructions to create a set of temporary partitions within a network accessible second computing system that correspond the affected set of partitions of the first computing system;
program instructions to determine one or more sets of computing resources, of the second computing system, corresponding to the created set of temporary partitions;
program instructions to delete the set of temporary partitions; and
program instructions to provision a set of partitions within the second computing system based, at least in part, on the determined one or more sets of computing resources corresponding to the affected set of partitions.

10. The computer program product of claim 9, wherein program instructions to create the set of temporary partitions within the second computing system further comprises:
program instructions to identify a set of computing resources for an affected partition of the set of affected partitions based on a set of dictates corresponding to the affected partition of the set of affected partitions;
program instructions to determine whether the second computing system has sufficient unallocated computing resource to create a temporary partition based on the set of dictates corresponding to the affected partition; and
program instruction to respond to determining that the second computing system has sufficient unallocated computing resource to create a temporary partition based on the set of dictates corresponding to the affected partition by creating the temporary partition corresponding to the partition of the set of the affected partitions.

11. The computer program product of claim 9, further comprising:
program instructions to determine that the second computing system that includes sufficient unallocated computing resources to provision the set of affected partitions within the second computing system based on a configuration snapshot corresponding to each partition of the set of affected partitions.

12. The computer program product of claim 10, wherein the temporary partition is over-allocated with computing resources by a threshold amount to accommodate an increase usage of computing resources to accommodate computing resources consumed by a hypervisor of the second computing system to create the temporary partition and virtualize one or more computing resource of the second computing system.

13. The computer program product of claim 10, wherein program instructions to determine whether the second computing system has sufficient unallocated computing resource to create a temporary partition based on the set of dictates corresponding to the affected partition further comprises:
program instructions to determine whether the second computing system has sufficient unallocated computing resources based on a hierarchy of computing resource types; and
program instructions to identify memory as a first computing resource type of the hierarchy of computing resource types.

14. The computer program product of claim 10, wherein the set of computing resources for each partition of the set of affected partitions is dictated based, at least in part on a configuration snapshot corresponding to the partitions of the set of affected partitions, wherein the configuration snapshot of a partition is created based on information obtained by from a hypervisor of the first computing system, and wherein configurations snapshots are stored on a network accessible computing system that is not affected by the event that affects the first computing system.

15. A computer system for determining and managing computing resources within a virtualized computing environment, the computer system comprising:
one or more computer processors;
one or more computer readable storage media;
program instructions stored on the computer readable storage media for reading/execution by at least one of the one or more computer processors, the program instructions further comprising:
program instructions to identify a set of partitions affected by an event within a first computing system, wherein the set of affected partitions is identified for restart;
program instructions to create a set of temporary partitions within a network accessible second computing system that correspond the affected set of partitions of the first computing system;
program instructions to determine one or more sets of computing resources, of the second computing system, corresponding to the created set of temporary partitions;
program instructions to delete the set of temporary partitions; and
program instructions to provision a set of partitions within the second computing system based, at least in part, on the determined one or more sets of computing resources corresponding to the affected set of partitions.

16. The computer system of claim 15, wherein program instructions to create the set of temporary partitions within the second computing system further comprises:
program instructions to identify a set of computing resources for an affected partition of the set of affected partitions based on a set of dictates corresponding to the affected partition of the set of affected partitions;
program instructions to determine whether the second computing system has sufficient unallocated computing resource to create a temporary partition based on the set of dictates corresponding to the affected partition; and
program instruction to respond to determining that the second computing system has sufficient unallocated computing resource to create a temporary partition based on the set of dictates corresponding to the affected partition by creating the temporary partition corresponding to the partition of the set of the affected partitions.

17. The computer system of claim 15, further comprising:
program instructions to determine that the second computing system that includes sufficient unallocated computing resources to provision the set of affected partitions within the second computing system based on a configuration snapshot corresponding to each partition of the set of affected partitions.

18. The computer system of claim 16, wherein the temporary partition is over-allocated with computing resources by a threshold amount to accommodate an increase usage of computing resources to accommodate computing resources consumed by a hypervisor of the second computing system to create the temporary partition and virtualize one or more computing resource of the second computing system.

19. The computer system of claim 16, wherein program instructions to determine whether the second computing system has sufficient unallocated computing resource to create a temporary partition based on the set of dictates corresponding to the affected partition further comprises:
program instructions to determine whether the second computing system has sufficient unallocated computing resources based on a hierarchy of computing resource types; and
program instructions to identify memory as a first computing resource type of the hierarchy of computing resource types.

20. The computer system of claim 16, wherein the set of computing resources for each partition of the set of affected partitions is dictated based, at least in part on a configuration snapshot corresponding to the partitions of the set of affected partitions, wherein the configuration snapshot of a partition is created based on information obtained by from a hypervisor of the first computing system, and wherein configurations snapshots are stored on a network accessible computing system that is not affected by the event that affects the first computing system.
